(19) United States
(12) Patent Application Publication
(10) Pub. No.: US 2003/0166349 A1
(43) Pub. Date: Sep. 4, 2003

(54) Pin installation guidance apparatus, methods and articles of manufacture

(76) Inventors: John P. Huss JR., Harrisburg, PA (US); Galen M. Martin, Camp Hill, PA (US)

Correspondence Address: Joseph A. Tessari, Esquire, TYCO TECHNOLOGY RESOURCES, Suite 450, 4550 New Linden Hill Road, Wilmington, DE, 19808-2952, US

(21) Appl. No.: 10/087,353

(22) Filed: Mar. 1, 2002

(51) Int. Cl. H01R 12/00

(52) U.S. Cl. 439/79

(57) ABSTRACT

Apparatus, methods and articles of manufacture for pin installation are shown, comprising one or more support surfaces above a pin array. These support surfaces permit a press fit mechanism to install the array by applying a force normal to the pin heads of the array and above the pin tails. A liquid curing to solid such as epoxy may be used to provide the surface. Alternatively a solid surface may be used.

### FIELD OF THE INVENTION

The present invention generally relates to articles of manufacture, apparatus and methods for installing pin connectors. More particularly, this invention relates to articles of manufacture, apparatus and methods for installing pin connectors on printed circuit boards and the like.

### BACKGROUND OF THE INVENTION

The assembly of electronic components is often done through modules. These modules contain pins to make the mechanical and electrical connections to a Printed Circuit Board (“PCB.”) Correctly assembling the pin modules with receptive modules, which usually have holes to receive the pins, may be difficult because the modules are usually designed to be press fit together. Care must be taken so that the pins, which are usually small and fairly fragile, are not bent upon press fit installation.

Assembly is complicated by the need for sufficient force to be used to insure the pins do not pop out of their receiving holes. For example, compliant pins, designed to contact the sides of receiving holes and thereby establish an electrical connection, are designed usually with some sort of deformable section, which may provide resistance upon insertion, and if not properly inserted may result in the pin being driven out of the hole.

Moreover, there is little room to operate when installing pin modules. The pins are usually very close together, in rows, in order to minimize space. However, this provides little room to insure precise installation. The problem is especially acute when installing right angle pins, which are subject to deformation. Moreover, if the right angle pins are complaint pins, both the angle and complaint nature of the pins may present installation difficulties.

Installation difficulties may be further compounded by an incorrect installation. For example, some pins on a given connector may be bent when installing, thus requiring removal of the entire connector and reinsertion or, more usually, replacement by a new connector.

Attempts have been made to solve installation problems. Installation tools may, for example, attempt, through a push bar, to press fit the pins into the holes. The push bar must be calibrated to evenly apply force on all the pins being installed. A less than even application of force may result in improper installation, bent pins, etc. Maintaining proper calibration for each installation may prove difficult, however, and constant recalibration of the push bar may lead to undesirable work flow.

Automated tooling, used to press fit, may straddle and back up a pin section while it is being installed. However, such tooling is complex and may be difficult to operate given the intricacies of pin installation. For example multiple pin installation requires extremely complex straddle and backup equipment initially, as well as maintenance of that equipment to insure that it operates within a small margin of error—the room between pins.

Pin organizers have also been tried to resolve the problem. However, a pin organizer may take up necessary room as the pin bearing component is being assembled. For example, for headers that are glued or bonded to castings, the organizer could potentially interfere with the bond that is being created.

Clips and the like also have been tried. But these may add components, increase the size of the modules, or add manufacturing complexity to the device.

Accordingly, it would be extremely beneficial if a small easy to operate guide could be used to assist in pin installation.

Therefore, it is an object of the present invention to provide a small, easy to operate guide to assist in pin installation.

It is a further object of the present invention to provide a small, easy to operate guide to assist in right angle pin installation.

### SUMMARY OF THE INVENTION

The summary, as well as the following detailed description of the invention, will be better understood when read in conjunction with the appended drawings. For the purpose of illustrating the invention, there are shown in the drawings, certain embodiment(s) which are presently preferred. It should be understood, however, that the invention is not limited to the precise arrangements and instrumentalities shown.

Preferred embodiments of the present invention provide one or more support surfaces above a pin array, permitting a press fit mechanism to apply a force above the pin tails of the array and normal to the pin heads of the array. In the preferred embodiments, epoxy is used to support and encapsulate the pin array by being applied within an enclosure surrounding the pins. When cured, the epoxy provides a support surface for the press fit mechanism. The epoxy also provides axial support along the downwardly directed bottom pin legs by surrounding the pin legs, as well as transverse support against force imposed upon the top pin legs, including the pin heads, such as when inserting or removing a connector. In other embodiments, support surface is provided through a solid surface, set within an enclosure surrounding the pins.

Additional objects, advantages and novel features of the invention will be set forth in part in the description and figures which follow, and in part will become apparent to those skilled in the art on examination of the following, or may be learned by practice of the invention.

### BRIEF DESCRIPTION OF THE DRAWINGS

FIG. 1 shows a plan view of a preferred embodiment.

FIG. 2 shows another view of the embodiment of FIG. 1.

FIG. 3 shows another view of the embodiment of FIG. 1.

FIG. 4 shows another view of the embodiment of FIG. 1.

FIG. 5 shows another view of the embodiment of FIG. 1.

FIG. 6 shows a plan view of another preferred embodiment.

FIG. 7 shows another view of the embodiment of FIG. 6.

FIG. 8 shows a plan view of another preferred embodiment.

FIG. 9 shows another view of the embodiment of FIG. 8.

FIG. 10 shows another view of the embodiment of FIG. 8.

FIG. 11 shows another view of the embodiment of FIG. 8.

### DETAILED DESCRIPTION OF THE PREFERRED EMBODIMENTS

Reference is now made to the accompanying Figures for the purpose of describing, in detail, the preferred embodiments of the present invention. The Figures and accompanying detailed description are provided as examples and are not intended to limit the scope of the claims appended hereto.

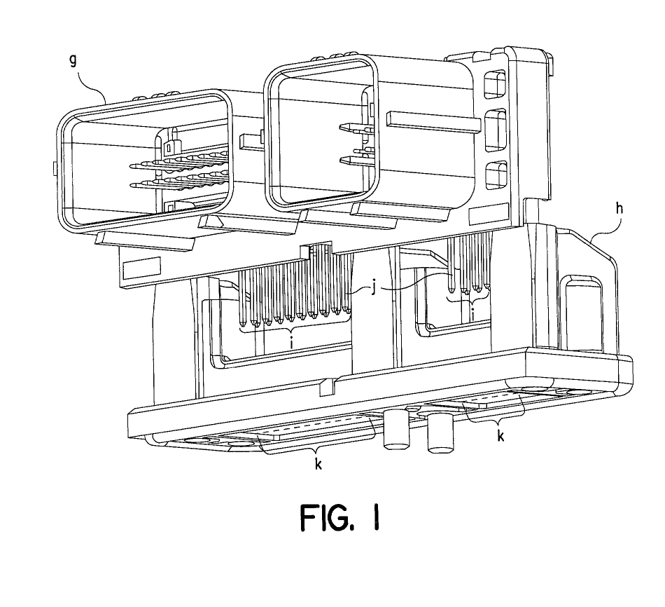

FIG. 1 shows a preferred embodiment of the present invention. Connector g is shown being inserted in header h of this embodiment. Pin tails i of the right angle pins j will be inserted within the recesses k in header h.

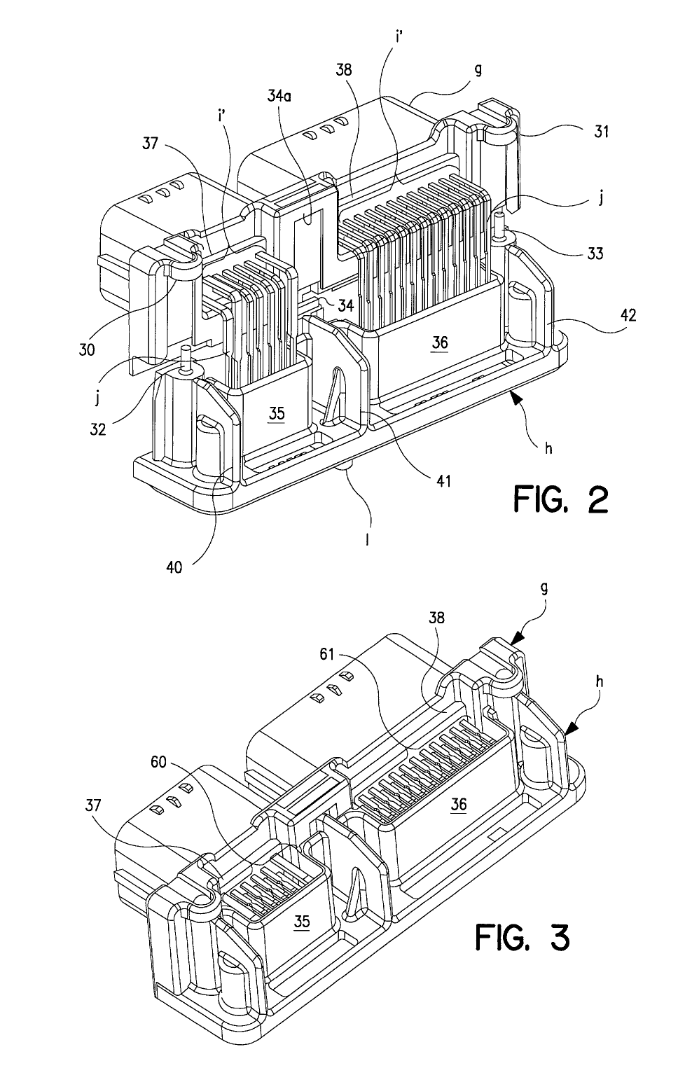

Another view of the embodiment of FIG. 1 is seen at FIG. 2 and shows the connector g being inserted in header h. Pins j depend downwardly upon insertion. Retention posts 32 and 33, supported via braces 40 and 42 respectively, fit within retention recesses 30 and 31 to seat connector g upon header h. Retention post 34, supported via brace 41 on header h also fits within complementary recess 34a in connector g. Retention post l, responsible for at least partial seating of the assembled component on the PCB, depends downwardly from header h.

FIG. 3 shows the assembled connector g and header h. Two enclosures, 60 and 61 are formed by walls 35 and 37 and walls 36 and 38, respectively, with pin tails i (not shown here; see FIG. 1) depending from the floor of each enclosure through recesses k (not shown here; see FIG. 1.) It should be noted that in this embodiment, as well as other preferred embodiments, the shape of the enclosure is determined by the pin array or arrays to be supported. In other embodiments, different shaped enclosures may be used so as to complement any desired pin arrangement.

Epoxy, which will form support surfaces as further described below, is dispensed into enclosures 60 and 61. Each enclosure is of appropriate integrity, so as to retain the epoxy without leakage. Thus, the edges of walls 35 and 37 and walls 36 and 38 must be effectively contiguous, so that there is no leakage. Additionally, the recesses k (not shown here; see FIG. 1) must suitably enclose pin tails i (not shown here; see FIG. 1) of the header g.

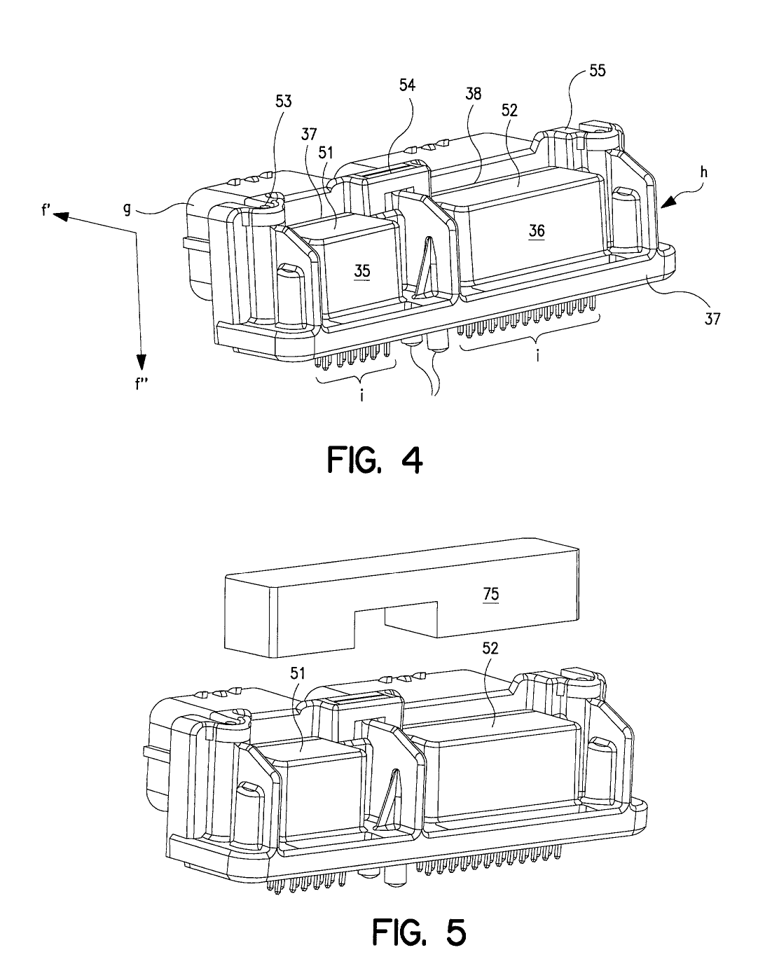

FIG. 4 shows a view of the embodiment of FIG. 3 once the epoxy has cured, thus providing pin array encapsulation, bonding the connector g and header h, as well as creating support surfaces 51 and 52 enclosed by walls 35, 36, 37 and 38. Both support surfaces 51 and 52 as well as surfaces 53-55, may be used to press fit the assembled connector (which term is used for both the connector g and header h once they have been mated) onto a PCB as they provide surfaces for tooling or hand contact independently of the pins. It should be noted that use of surfaces 53-55 alone will not provide an appropriate force vector for pin installation, as force upon those surfaces will tend to create upward force rather than the desired downward force on the pins. Therefore, in this and other preferred embodiments, it should be noted that any particular support surface comprising the embodiment is placed where a downward vector can be applied above the pin arrays.

The support surfaces 51 and 52 provide for tool or other contact, thus permitting force to be applied to the top of the connector—header component for installation on a PCB using a flat rock, modified flat rock or other similar press fit type tool. FIG. 5 shows an example of press fit tooling 75 used for the surfaces 51 and 52 of the embodiment of FIG. 3. It should also be noted that, in this embodiment, the cured epoxy in enclosures 60 and 61 axially supports the downwardly directed bottom pin legs and therefore provides support as the pins are installed, thus lessening the chance of bending or other alteration. Moreover, the cured epoxy provides transverse support against force imposed upon the top pin legs, including the pin heads, such as when inserting or removing a connector.

In other embodiments, support surfaces may be provided above the pins by other means. For example, a roof, cap or other solid structure may be interposed on top of any pin array enclosures, thus providing a support surface or surfaces for the imposing of force above the pins. Moreover, any liquid material known in the art, that is suitably dielectric and cures or dries, thus providing a support surface, could be used as well.

Additionally, in yet other embodiments, support surfaces are not necessary, and the tooling can be placed directly upon the enclosures upper surface or surfaces, which is so configured so as to be compatible with press fit tooling as is known in the art. Of course, these enclosures may have different surfaces according to the type of mating tooling. Additionally, in yet other embodiments, posts or other extensions, depending upwardly from the base of a pin guide, may be used to transmit the desired force to the base provided those extensions are configured in a manner sufficient to convey the force along the appropriate vector for pin installation.

Returning to FIG. 4, lines f′-f″ show how force is desirably applied in the embodiments. Direction f′ is the direction of the top leg of the right angle pins (shown as i′ in FIG. 2). Direction f″ shows the vector for the desired application of force—normal to the top leg of the right angle pins.

It should be noted that although a support surface alone proximate to the top leg of the pins and providing for a force normal to the top leg of any pin array (which term as used herein includes any arrangement of more than one pin) may be used in any particular embodiment, the preferred embodiments also utilize a pin guide, which provides guidance for a pin array as an installation force is applied. In the preferred embodiments, the pin guide comprises a conduit for a pin array, providing lateral support for the pin array so the pin array is supported as it is pressed downwardly through use of the support surface. Of course, as was noted above with regard to the embodiment of FIG. 3, epoxy may serve as an additional support for the pin array as it is installed. In the preferred embodiments, a pin guide is so configured as to be affixed to a housing and/or connector and/or otherwise supported so as to provide additional support to the conduit and thus to the pin.

The composition of the embodiments described above and below can be of any materials known in the art, as long as adequate structural rigidity and dielectric properties exist.

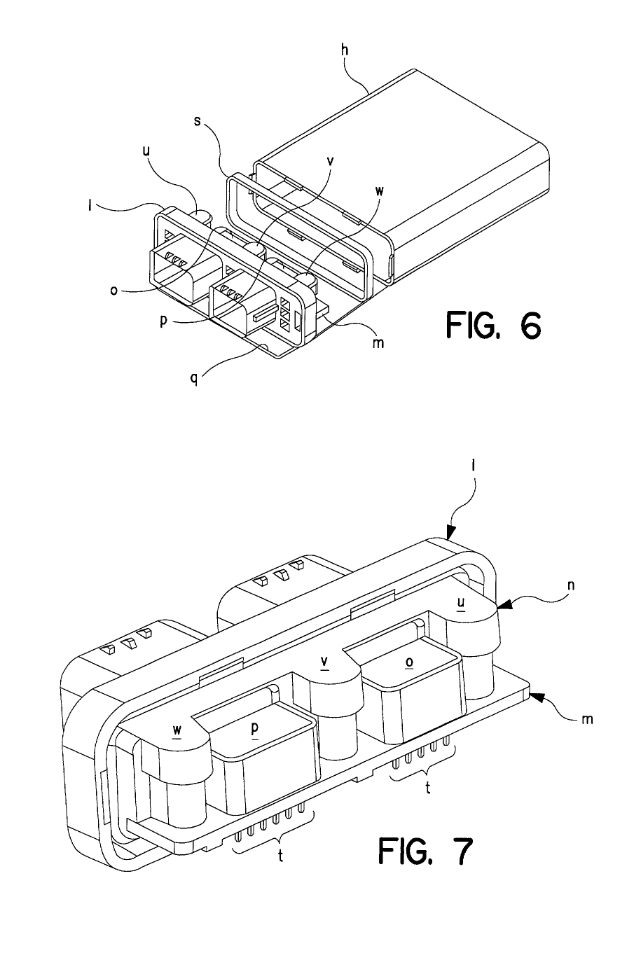

Another embodiment is shown in FIG. 6. Here the connector shown generally at l is assembled to a header m with pin guide. The surfaces shown generally at o and p provide contact for press fitting the assembly. The PCB at q, is the recipient for the pins prior to installation in the module housing r. Gasket s assists in sealing the assembly within the module housing r. Surfaces u, v and w could also be used to provide support for press fit tooling, if desired.

FIG. 7 shows the embodiment of FIG. 6 in greater detail. This particular embodiment, once pin arrays t are press fit upon PCB q (seen in FIG. 6) fits within module housing r and is sealed with gasket s, as had been seen in FIG. 4.

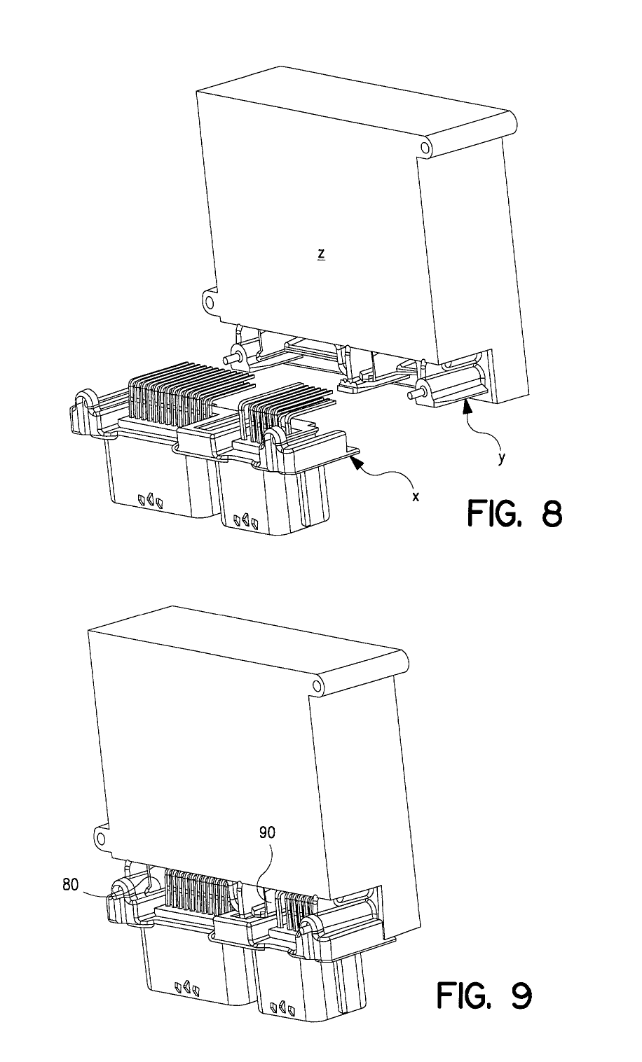

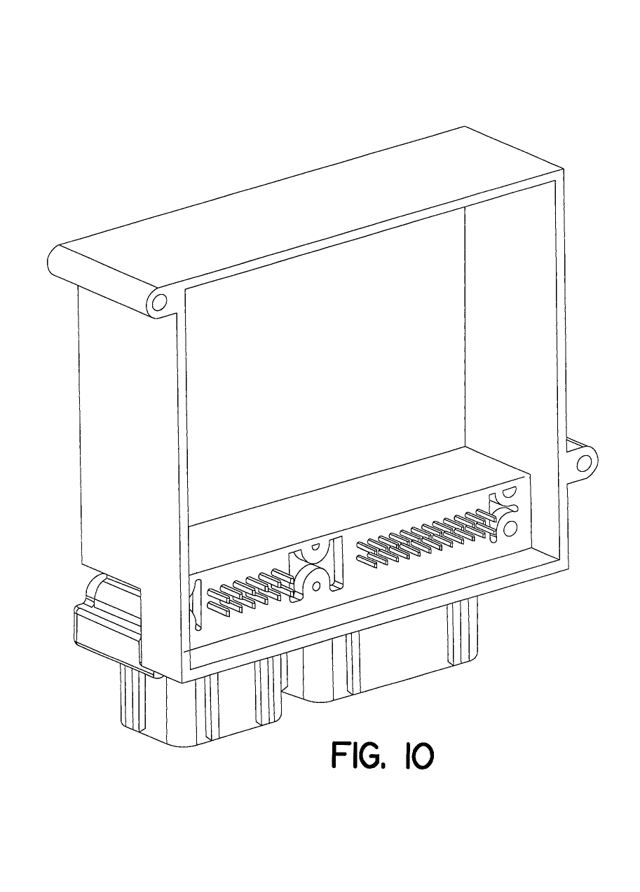

Yet another embodiment is shown in FIG. 8. Here the header x and connector y are installed in module housing z. The assembly of header x, connector y, and housing z provides enclosures 80 and 90, seen in FIG. 9, for the application of encapsulant which provides support to the pin arrays and so supports the pin arrays during assembly of a PCB.

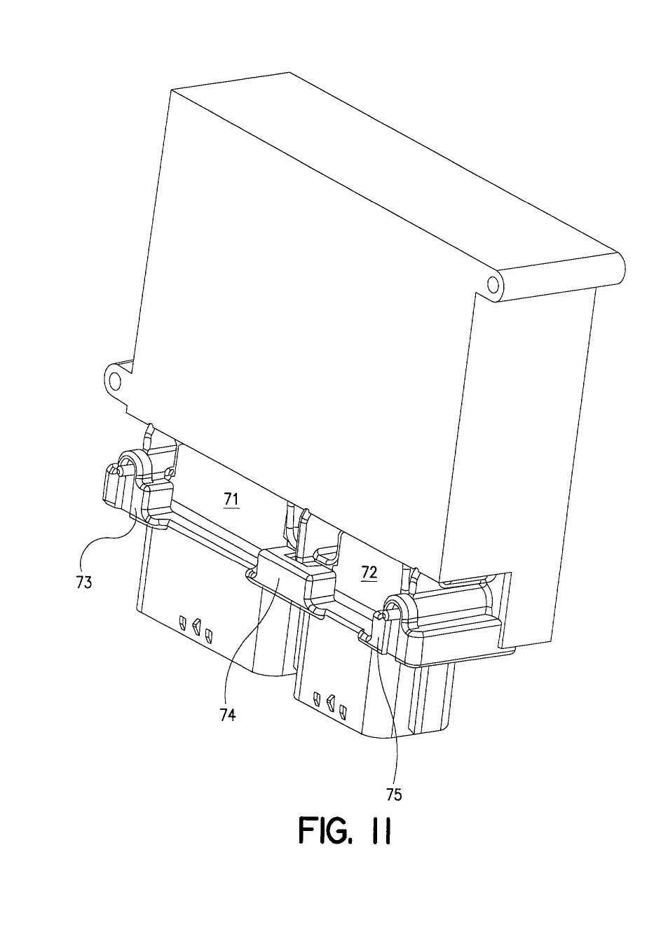

It can be seen in FIG. 10 that this module housing is open on the bottom, so as to fit on a PCB, and so here the difficulty of appropriately setting the pins is affected by the module housing z, as care must be taken to press above the pin arrays while minimizing pressure on the upper surface of the module housing. Otherwise, the force imposed on the pins may be adversely affected by any force imposed on the module housing z. This is because force on the top of the module housing z may make the module housing z bend and lift up along the perimeters, and so pull the pins upward.

Thus, as can be seen when turning to FIG. 11, surfaces 71, 72, 73, 74 and 75 can be used to supply a force normal to the shoulder of the pins, by providing a desired support surface for press fit or other tooling. This force may be discrete from any force applied to the housing.

The above description and the views and material depicted by the figures are for purposes of illustration only and are not intended to be, and should not be construed as, limitations on the invention.

Moreover, certain modifications or alternatives may suggest themselves to those skilled in the art upon reading of this specification, all of which are intended to be within the spirit and scope of the present invention as defined in the attached claims.

We claim:

1. An article of manufacture for installing pin connectors comprising a support surface for right angle pin array installation, wherein said support surface is configured to receive a force at an angle normal to the pin heads of said pin array.

2. An apparatus for installing pin connectors comprising:
a pin array;
a support surface means; and,
an enclosure means for receiving said support surface means;
wherein said pin array is at least partially enclosed within said enclosure means.

3. An apparatus as in claim 2 wherein said support surface means further comprises an encapsulation means.

4. An apparatus as in claim 3 wherein said encapsulation means further comprises an epoxy means.

5. An apparatus as in claim 3 wherein said encapsulation means further comprises a transverse support means for said pin array.

6. An apparatus as in claim 3 wherein said encapsulation means further comprises an axial support means for said pin array.

7. An apparatus as in claim 3 wherein said encapsulation means further comprises an encapsulation means for surrounding said pin array.

8. An apparatus as in claim 2 further comprising a pin guide, wherein said pin array is at least partially enclosed within said pin guide as well as within said encapsulation means.

9. An apparatus for installing pin connectors comprising:
a connector means;
a pin array;
a header means; and
a support means;
wherein said connector means is matingly engaged with said header means, thus forming an enclosure for said pin array, and said support surface means provides for a downward force to be applied above a pin array.

10. An apparatus as in claim 9 further comprising means for bonding said connector means and said header means.

11. An apparatus as in claim 9 further comprising a pin guide, wherein said pin array is at least partially enclosed within said pin guide as well as within said encapsulation means.

12. An method for installing pin connectors comprising:
providing a support surface on a connector and housing, with said housing having a floor from which pin tails depend;
applying a force on said support surface in order to install said connector and housing to a printed circuit board.

13. A method as in claim 12, further comprising
providing a pin array within a connector;
providing a housing;
assembling said connector and housing so that pin tails form said pin array tails depend from said housing;
providing a support surface; and,
applying a force on said support surface in order to install said connector and housing to a printed circuit board.

14. A method as in claim 13 further comprising the step of providing an enclosure means for receiving said support surface means wherein said pin array is at least partially enclosed within said enclosure means.

15. A method as in claim 13 wherein the step of providing a support surface further comprises providing an encapsulation means.

16. A method as in claim 15 wherein the step of providing a said encapsulation means further comprises providing an epoxy means.

17. A method as in claim 15 wherein the step of providing said encapsulation means further comprises providing a transverse support means for said pin array.

18. A method as in claim 15 wherein the step of providing said encapsulation means further comprises providing an axial support means for said pin array.

19. A method as in claim 15 wherein the step of providing said encapsulation means further comprises providing an encapsulation means for surrounding said pin array.

20. A method for installing pin connectors comprising:
providing a connector means;
providing a pin array;
providing a header means; and
providing a support means;
wherein said connector means is matingly engaged with said header means, thus forming an enclosure for said pin array, and said support surface means provides for a downward force to be applied above a pin array.

21. A method as in claim 20 further comprising the step of bonding said connector means and said header means.
